(19) United States
(12) Patent Application Publication
(10) Pub. No.: US 2012/0306937 A1
(43) Pub. Date: Dec. 6, 2012

(54) BACKLIGHT MODULE, DISPLAY SYSTEM, AND DRIVING METHOD OF BACKLIGHT MODULE

(75) Inventors: Hui CHU-KE, Hsin-Chu (TW); Sheng-Wen CHENG, Hsin-Chu (TW)

(73) Assignee: AU OPTRONICS CORP., HSINCHU (TW)

(21) Appl. No.: 13/300,742

(22) Filed: Nov. 21, 2011

(30) Foreign Application Priority Data
May 31, 2011 (TW) 100119114

(51) Int. Cl. G09G 5/10; G09G 3/36; G02F 1/1335

(52) U.S. Cl. 345/690; 349/61; 345/102

(57) ABSTRACT

A backlight module adapted to a display device for displaying multiple image frames to form an image. Herein the backlight module includes multiple light-emitting units and a driving circuit. The light-emitting units are arranged along a first direction. The driving circuit is electrically coupled to the light-emitting units to thereby drive the light-emitting units sequentially to emit light. During the driving circuit drives the light-emitting units, a light-emitting time of the firstly-turned-on light-emitting unit in the light-emitting units for illuminating a current image frame of the image frames has a portion in an image driving time of the current image frame, and the other portion of the light-emitting time is in the image driving time of a successive image frame immediately following the current image frame. Moreover, the disclosure also provides a display system using the above backlight module and a driving method of backlight module.

### TECHNICAL FIELD

The disclosure relates to the field of display technology, and more particularly to a backlight module, a display system and a driving method of backlight module.

### BACKGROUND

In order to meet more abundant visual experience, the image display market gradually is converted from two-dimensional image displays into three-dimensional image displays, making the process of image displays and system architectures be very different from that in the past. Currently, most of methods of displaying three-dimensional image by shutter use 240 Hz display to present the left-eye image and right-eye image, so that the left-eye image and right-eye image are received by the people's left and right eyes at different times to achieve the effect of stereo images synthesized by human brain. Ideally, the left-eye image should not be seen by right eye, and the right-eye image should not be seen by the left eye, therefore the signal crosstalk problem conventionally is improved by use of black frame insertion and the on-off of backlight cooperative with the opening times of left-eye and right-eye lenses to reduce the occurrence of images being wrongly seen.

However, because the cost of 240 Hz display is relatively high and those displays which have the relatively lower refresh rate such as 120 Hz displays would cause serious signal crosstalk problem resulting from the lack of time for black frame insertion, therefore, one of the purposes of developing the disclosure is to let the displays having relatively low fresh rate achieve the picture quality of 240 Hz even more display.

### SUMMARY OF DISCLOSURE

Specifically, an embodiment of the disclosure relates to a backlight module adapted to a display device for displaying multiple image frames to form an image. In this embodiment, the backlight module includes multiple light-emitting units and a driving circuit. The light-emitting units are arranged along a first direction. The driving circuit is electrically coupled to the light-emitting units to thereby drive the light-emitting units sequentially to emit light. During the driving circuit drives the light-emitting units, a light-emitting time of the firstly-turned-on light-emitting unit in the light-emitting units for illuminating a current image frame of the image frames has a portion in an image driving time of the current image frame and another portion in the image driving time of a successive image frame immediately following the current image frame.

Another embodiment of the disclosure relates to a display system including a display panel and backlight module. The display panel includes multiple pixel groups. These pixel groups are sequentially driven to display image frames. The backlight module includes multiple light-emitting units and a driving circuit. The light-emitting units are arranged along a first direction, and each of the light-emitting units illuminates a part of these pixel groups. The driving circuit is electrically coupled to the light-emitting units to thereby drive the light-emitting units sequentially to emit light. During the driving circuit drives the light-emitting units, a light-emitting time of the firstly-turned-on light-emitting unit in the light-emitting units for illuminating a current image frame of the image frames has a portion in an image driving time of the current image frame, and the other portion of the light-emitting time is in the image driving time of a successive image frame immediately following the current image frame.

Still another embodiment of the disclosure relates to a driving method of backlight module adapted to drive a backlight module including multiple light-emitting units to illuminate a display. The driving method in the embodiment includes following steps of: turning on the light-emitting units sequentially during displaying a current image frame; making a first light-emitting unit being firstly-turned-on in the light-emitting units for illuminating the current image frame continuously emit light; and turning off the first light-emitting unit after a predetermined time starting from display data for a successive image frame immediately following the current image frame start to be displayed.

### BRIEF DESCRIPTION OF THE DRAWINGS

The above embodiments of the disclosure will become more readily apparent to those ordinarily skilled in the art after reviewing the following detailed description and accompanying drawings, in which:

FIG. 1 is a partial schematic diagram of a three-dimensional (3D) display system according to one embodiment;

FIG. 2 is a schematic backlight control process in the case of the backlight module of FIG. 1 being equipped with two light-emitting units (i.e., corresponding to the backlight being operated with two-region scanning);

FIG. 3 is a schematic backlight control process in the case of the backlight module of FIG. 1 being equipped with more than two light-emitting units (i.e., corresponding to the backlight being operated with multi-region scanning);

FIG. 4A is an effect diagram of a simulated environment relevant to multiple light-emitting units of the backlight module during a single image frame driving process in which a light-emitting time t1 of the firstly-turned-on light-emitting unit crosses the border of two adjacent image frames and the lastly-turned-on light-emitting unit is turned on before closing a corresponding one of left-eye lens and right-eye lens; and

FIG. 4B is an effect diagram of a simulated environment relevant to multiple light-emitting units of the backlight module during a single image frame driving process in which a light-emitting time t2 of the firstly-turned-on light-emitting unit is in front of the border of two adjacent image frames and the lastly-turn-on light-emitting unit is turned on before closing a corresponding one of left-eye lens and right-eye lens.

### DETAILED DESCRIPTION OF EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

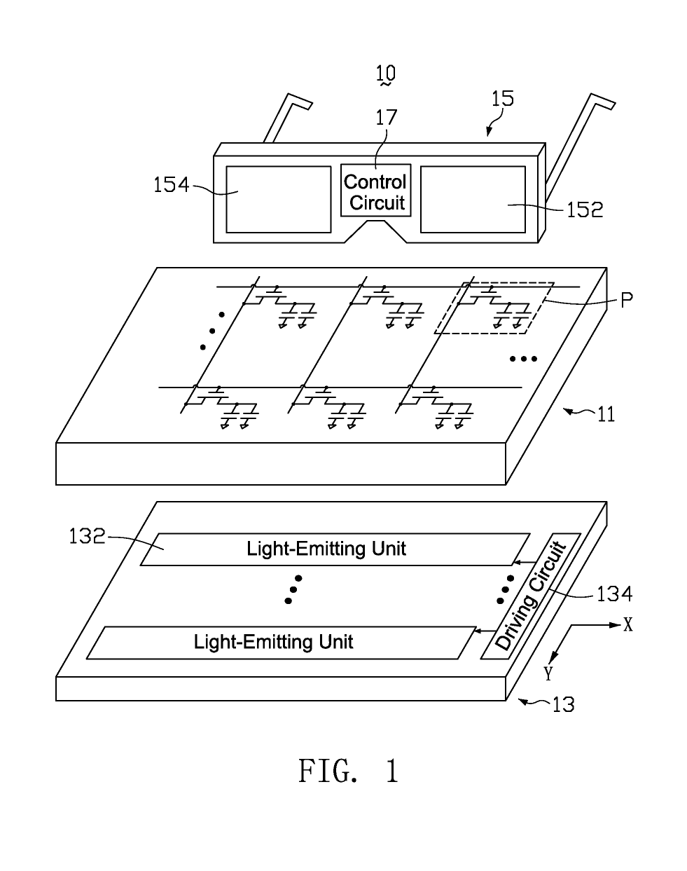

Referring to FIG. 1, which is a partial schematic diagram of a three-dimensional (3D) display system according to one embodiment. In the present embodiment, the 3D display system 10 includes a liquid crystal display panel 11, a backlight module 13, a stereo glasses e.g., shutter glasses 15, and a shutter glasses control circuit 17. Herein, the liquid crystal display panel 11 and the backlight module 13 constitute a display device, and the shutter glasses control circuit 17 can be fixed on the frame of the shutter glasses 15. In addition, the 3D display system 10 is not limited to include the liquid crystal display panel 11, and can include other non-self-luminous display panel instead.

A plurality of pixels P are formed on the liquid crystal display panel 11. Each pixel P usually includes a pixel transistor, a storage capacitor, and a display capacitor (such as liquid crystal capacitor). The pixels P can be divided into several groups as needed, for example, the pixels P electrically coupled to the same gate driving line can be classified into the same pixel group, or the pixels P electrically coupled to the adjacent gate driving lines can be classified into the same pixel group; and the pixel groups can be driven to display image frames sequentially.

The backlight module 13 includes a plurality of light-emitting units 132 (e.g., at least two) as backlighting, and a driving circuit 134. The plurality of light-emitting units 132 are arranged along a Y direction, and each light-emitting unit 132 illuminates a part of the pixel groups correspondingly, for example, one light-emitting unit 132 illuminates one or more pixel groups correspondingly. Herein, each light-emitting unit 132 includes one or more cold cathode fluorescent Lamps (CCFL), or one or more rows of light-emitting diodes, but it is not limited to these. In addition, each light-emitting diode can include a plurality of light-emitting diodes arranged along an X direction. The driving circuit 134 is electrically coupled to the plurality of light-emitting units 132 to thereby drive the light-emitting units 132 sequentially to emit light. Herein, the driving circuit 134 can be set to open the light-emitting units 132 sequentially in a top-down scanning manner, for example, the driving circuit 134 can drive the plurality of light-emitting units 132 sequentially along the arrangement direction of the light-emitting units 132, or drive the plurality of light-emitting units 132 sequentially along the opposite direction with respect to the arrangement order of the light-emitting units 132. However, the present embodiment is not limited to this, in other embodiments, the left-right scanning manner can also be adopted. In addition, in the present embodiment, using a scanning manner to drive the light-emitting units 132 to start to emit light can reduce the crosstalk phenomenon caused by the proliferation of the light source.

The shutter glasses 15 include a left-eye lens 152 and a right-eye lens 154. The shutter glasses control circuit 17 is electrically coupled to the shutter glasses 15 to control the opening and closing of the left-eye lens 152 and right-eye lens 154. Usually, the left-eye lens 152 and right-eye lens 154 open asynchronously.

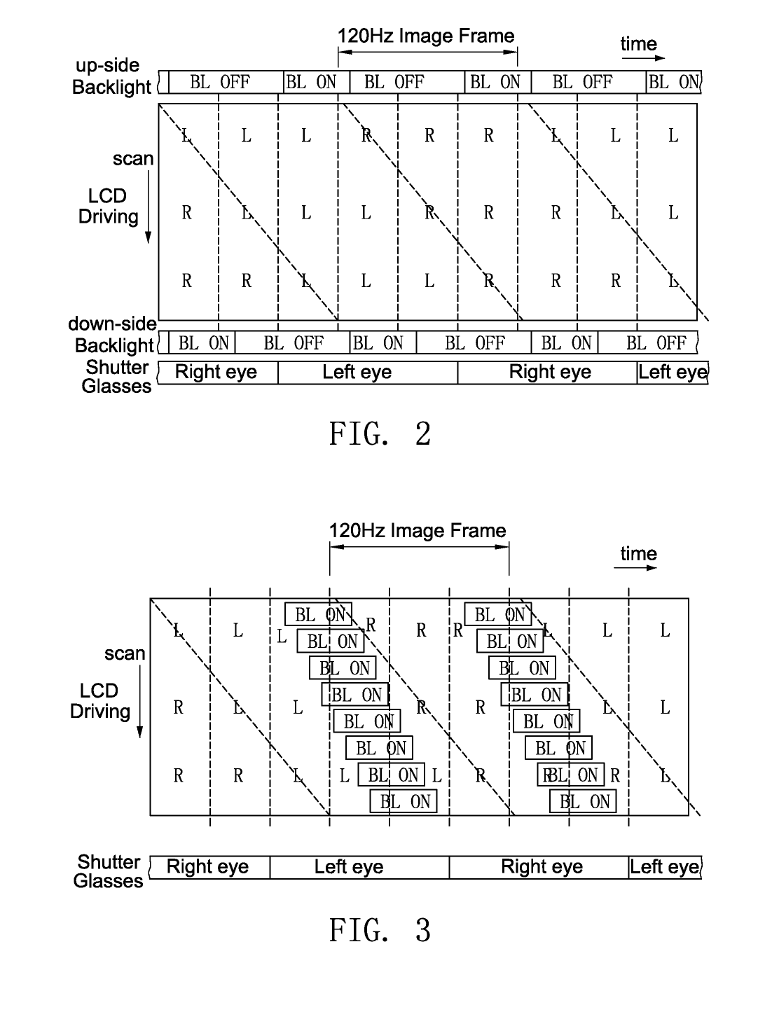

Please refer to FIGS. 1 and 2 together, FIG. 2 is a schematic backlight control process in the case of the backlight module 13 being equipped with two light-emitting units (i.e., corresponding to the backlight being operated with two-region scanning). In FIG. 2, “L” represents data signals of left eye, and “R” represents data signals of right eye. The data signals of left eye L are supplied to pixel group to display from top to bottom in the process of driving left-eye image frame, likewise, the data signals of right eye R are supplied to pixel group to display from top to bottom in the process of driving right-eye image frame. The two light-emitting units are turned on as up-side and down-side of backlight respectively in the top-down scanning manner. In other words, the order of the drive circuit 134 driving the two light-emitting units is the same with the order of the corresponding display regions of the display devices illuminated by the two light-emitting respectively being scanned.

As shown in FIG. 2, under the 120 Hz display system, in the driving process of single left-eye or right-eye image frame, the up-side of backlight is turned on firstly, the down-side of backlight is turned on later than the up-side of backlight and before the corresponding left-eye lens or right-eye lens being turned off. The light-emitting time of the up-side of backlight (corresponding to duration of BL ON) has a portion in a current image frame such as the left-eye image frame (or the right-eye image frame), and the other portion is in the successive image frame immediately following the current image frame such as the right-eye image frame (or the left-eye image frame). In other words, the light-emitting time of the firstly-turned-on light-emitting unit crosses the border of two adjacent image frames; and the closing time of lens for left eye is before the time of the firstly-turned-on up-side of backlight in the successive image frame (e.g., the right-eye image frame), the closing time of lens for right eye is before the time of the firstly-turned-on up-side of backlight in the successive image frame (such as the left-eye image frame). Moreover, in a left-eye image frame, the closing time of the down-side of backlight is before the closing time of the lens for left eye; likewise, in a right-eye image frame, the closing time of the down-side of backlight is before the closing time of the lens for right eye.

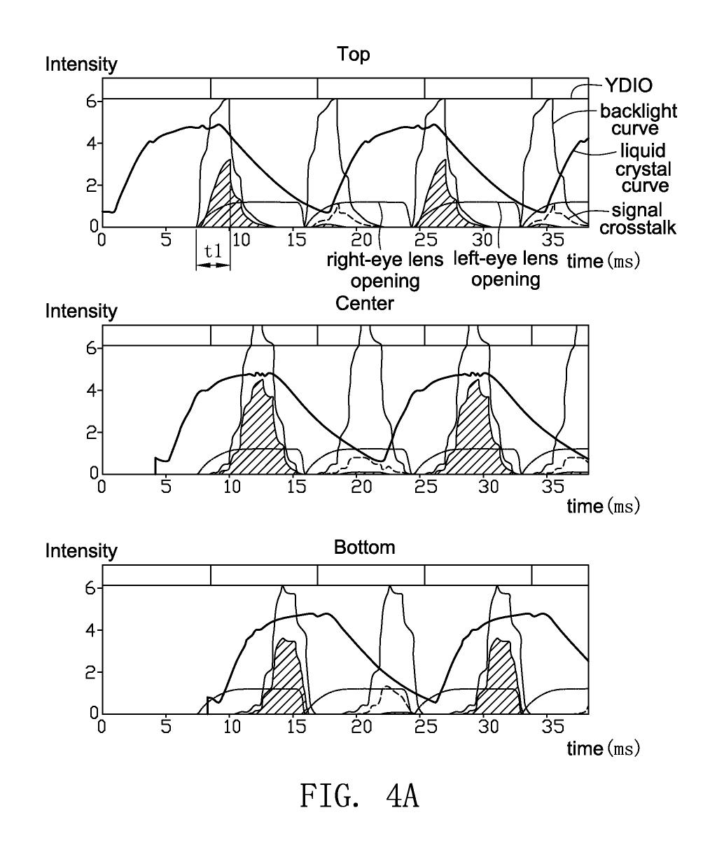

Please refer to FIGS. 1 and 3, FIG. 3 is the backlight control process in the case of the backlight module 13 being equipped with more than two light-emitting units (i.e., corresponding to the backlight being operated with multi-region scanning). In FIG. 3, “L” is for data signals of left eye, and “R” is for data signals of right eye, the data signals of left eye are supplied to pixel group to display from top to bottom in the process of driving left-eye image frame; likewise, the data signals of right eye are supplied to pixel group to display from top to bottom in the process of driving right-eye image frame. The light-emitting units 132 such as eight light-emitting units, are turned on in the top-down scanning manner sequentially, and the light-emitting start time of every light-emitting unit 132 is equal. In other words, the order of the driving circuit 134 driving the light-emitting units 132 is the same with that of corresponding display regions of the display device illuminated by the light-emitting units 132 respectively being scanned.

As shown in FIG. 3, for the 120 Hz display system, in the driving process of single left-eye or right-eye image frame, the topmost light-emitting unit is turned on firstly, the downmost light-emitting unit is turned on lastly and before the corresponding lens for left eye or right eye being turned off. The light-emitting time of the firstly-turned-on light-emitting unit (corresponding to duration of BL ON) has a portion in a current image frame such as the left-eye image frame (or the right-eye image frame), and the other portion is in the successive image frame immediately following the current image frame such as the right-eye image frame (or the left-eye image frame). In other words, the light-emitting time of the firstly-turn-on light-emitting unit crosses the border of two adjacent image frames.

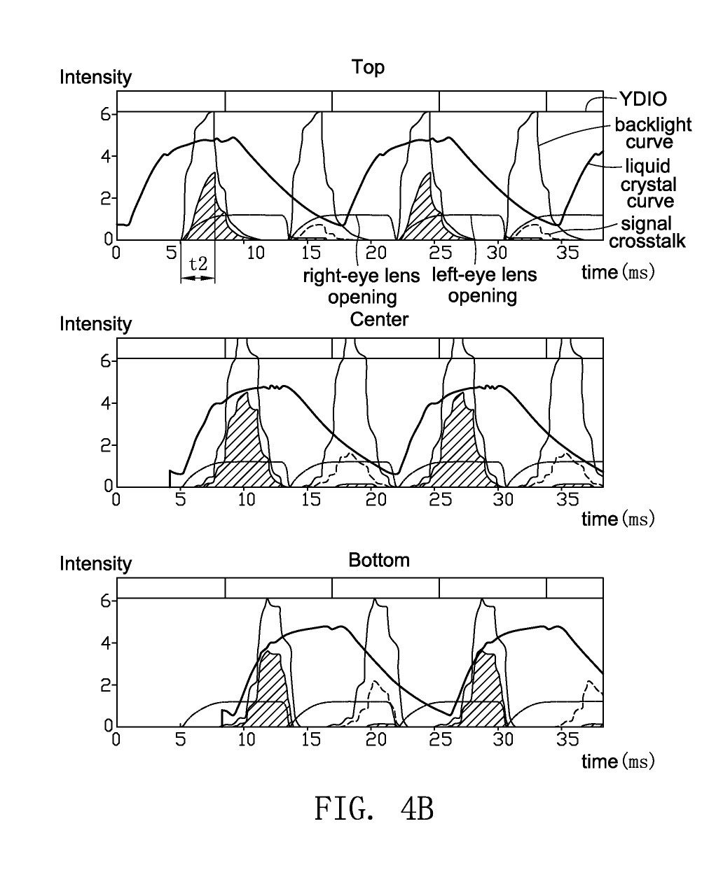

Please refer to FIGS. 1, 4A and 4B, FIG. 4A is an effect diagram of a simulated environment relevant to multiple light-emitting units 132 of the backlight module 13 during a single image frame driving process in which a light-emitting time t1 of the firstly-turned-on light-emitting unit 132 crosses the border of two adjacent image frames and the lastly-turned-on light-emitting unit 132 is turned on before closing a corresponding one of left-eye lens and right-eye lens. FIG. 4B is an effect diagram of a simulated environment relevant to multiple light-emitting units 132 of the backlight module 13 during a single image frame driving process in which a light-emitting time t2 of the firstly-turned-on light-emitting unit 132 is in front of the border of two adjacent image frames and the lastly-turned-on light-emitting unit 132 is turned on before closing a corresponding one of left-eye lens and right-eye lens. In FIGS. 4A and 4B, YDIO is a start signal of image frame and every vertical line of YDIO represents a start pulse, and the light-emitting unit used to illuminate the topmost region of the display device in the backlight module 13 is turned on firstly.

Comparing the degrees of signal crosstalk on the top, center, and bottom of the display device in FIGS. 4A and 4B, it can be found that: in the case that the light-emitting time t1 of the firstly-turned-on light-emitting unit 132 of the backlight module showed in FIG. 4A crosses the border of two adjacent image frames, the degree of signal crosstalk at the center of the display device is lower, that is, the degree of signal crosstalk is suppressed effectively. In addition, it is also can be seen from FIG. 4A that, the closing time of the lens for left eye is before the opening time of the successive right-eye image frame; likewise, the closing time of the lens for right eye is before the opening time of the successive left-eye image frame, and a light-emitting start time of the lens for left eye is synchronous with the light-emitting start time of the firstly-turned-on light-emitting unit (i.e., the beginning of the light-emitting time t1). In addition, it is noted that, the case that the light-emitting time of the firstly-turned-on light-emitting unit in the driving process of single image frame being put behind the border between two adjacent image frames (not shown) has poor effect to suppress the signal crosstalk.

In addition, according to the above description, the driving method of the backlight module 13 in the present embodiment can be summarized as follows: turning on the light-emitting units 132 of the backlight module 13 sequentially in a current image frame such as a left-eye image frame (or a right-eye image frame); making the firstly-turned-on light-emitting unit such as the topmost light-emitting unit of the light-emitting units 132 for illuminating the current image frame continuously emit light; and turning off the firstly-turned-on light-emitting unit after a predetermined time from the display data of a successive image frame such as the right-eye image frame (or the left-eye image frame) immediately following the current image frame starting to be displayed.

Furthermore, it is noted that, the backlight module in the present embodiment is not limited to the 3D display system with 120 Hz fresh rate, and can also be applied to the 3D display system with other fresh rate, for example, the 240 Hz 3D display system still can achieve good effect for suppressing signal crosstalk in the case that there is no black frame insertion.

In summary, the present embodiment is to reduce the degree of signal crosstalk effectively and to achieve better picture quality by making a light-emitting time of the firstly-turned-on light-emitting unit in the light-emitting units for illuminating a current image frame of the image frames has a portion in an image driving time of the current image frame and another portion in the image driving time of a successive image frame immediately following the current image frame, that is, to reduce the degree of signal crosstalk effectively by controlling the turn-on time of the backlight and thereby achieve better picture quality.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module adapted to a display device for displaying multiple image frames to form an image, the backlight module comprising:
a plurality of light-emitting units arranged along a first direction; and
a driving circuit electrically coupled to the light-emitting units to thereby drive the light-emitting units sequentially to emit light,
wherein during the driving circuit drives the light-emitting units, a light-emitting time of a firstly-turned-on light-emitting unit in the light-emitting units for illuminating a current image frame of the image frames has a portion in an image driving time of the current image frame and another portion in the image driving time of a successive image frame immediately following the current image frame.

2. The backlight module according to claim 1, wherein an order of the driving circuit driving the light-emitting units is the same with an order of corresponding display regions of the display device illuminated respectively by the light-emitting units being scanned in the current image frame.

3. The backlight module according to claim 2, wherein the corresponding display region of the display device illuminated by the firstly-turned-on light-emitting unit of the light-emitting units comprises the topmost region of the display device.

4. The backlight module according to claim 1, wherein the driving circuit drives the light-emitting units sequentially along the first direction.

5. The backlight module according to claim 1, wherein the driving circuit drives the light-emitting units sequentially along a direction opposite to the first direction.

6. A display system comprising:
a display panel comprising a plurality of pixel groups, wherein the pixel groups are adapted to be sequentially driven to display image frames; and
a backlight module comprising:
a plurality of light-emitting units arranged along a first direction, and each of the light-emitting units for illuminating a part of the pixel groups; and
a driving circuit electrically coupled to the light-emitting units to thereby drive the light-emitting units sequentially to emit light, wherein during the driving circuit drives the light-emitting units, a light-emitting time of the firstly-turned-on light-emitting unit in the light-emitting units for illuminating a current image frame of the image frames has a portion in an image driving time of the current image frame, and the other portion of the light-emitting time is in the image driving time of a successive image frame immediately following the current image frame.

7. The display system according to claim 6, wherein an order of the driving circuit driving the light-emitting units is the same with an order of a part of the pixel groups illuminated respectively by the light-emitting units being driven in an image driving time of any one of the image frames.

8. The display system according to claim 6, wherein the driving circuit drives the light-emitting units sequentially along the first direction.

9. The display system according to claim 6, wherein the driving circuit drives the light-emitting units sequentially along an opposite direction with respect to the first direction.

10. The display system according to claim 6, wherein a display region of the display panel illuminated by the firstly-turned-on light-emitting unit of the light-emitting units comprises the topmost display region of the display panel.

11. The display system according to claim 6, further comprising:
a shutter glasses comprising a first lens and a second lens; and a shutter glasses control circuit electrically coupled to the shutter glasses, wherein an opening start time of the first lens is synchronous with a light-emitting start time of the firstly-turned-on light-emitting unit.

12. The display system according to claim 11, wherein the first lens and the second lens open asynchronously.

13. The display system according to claim 11, wherein a closing time of the first lens is before the image driving time of the successive image frame.

14. A driving method of backlight module, adapted for driving a backlight module comprising a plurality of light-emitting units for illuminating a display, the driving method comprising:
turning on the light-emitting units sequentially in a current image frame;
making a first light-emitting unit being firstly-turned-on in the light-emitting units for illuminating the current image frame continuously emit light; and
turning off the first light-emitting unit after a predetermined time starting from display data of a successive image frame immediately following the current image frame start to be displayed.

15. The driving method according to claim 14, wherein an order of the light-emitting units being driven is the same with an arrangement order of the light-emitting units.

16. The driving method according to claim 14, wherein an order of the light-emitting units being driven is correspondent with an order of display data being supplied for the current image frame.
